(19) United States
(12) Patent Application Publication
(10) Pub. No.: US 2009/0053107 A1
(43) Pub. Date: Feb. 26, 2009

(54) MICROFLUID DEVICE AND METHOD FOR SETTING UP A MICROFLUID DEVICE

(75) Inventor: Holger Dirac, Birkeroed (DK)

Correspondence Address: MCCORMICK, PAULDING & HUBER LLP, CITY PLACE II, 185 ASYLUM STREET, HARTFORD, CT, 06103, US

(73) Assignee: DANFOSS A/S, Nordborg (DK)

(21) Appl. No.: 12/093,816

(22) PCT Filed: Nov. 18, 2005
(86) PCT No.: PCT/EP05/12349

§ 371 Date: Jul. 16, 2008

(51) Int. Cl. B01J 19/00; B29C 65/00; B32B 38/00

(52) U.S. Cl. 422/68.1; 156/293; 156/217; 156/242

(57) ABSTRACT

This invention concerns a microfluid device (1) comprising a bag (3) inside a housing (2), wherein the bag (3) is made of a flexible material and the bag (3) is attached to a mounting (4), and a method for setting up a microfluid device. It is an object of the invention to simplify the construction of a microfluid device comprising a bag inside a housing and to simplify the installation of such a microfluid device. This is achieved in that the mounting (4) is a permanently fixed part of the housing (2). It is also achieved by a method for setting up a microfluid device, wherein at first, the mounting is fixed at the inside of the housing and then the bag is attached to the fixed mounting.

### CROSS REFERENCE TO RELATED APPLICATIONS

This application is entitled to the benefit of and incorporates by reference essential subject matter disclosed in International Patent Application No. PCT/EP2005/012349 filed on Nov. 18, 2005.

### FIELD OF THE INVENTION

This invention concerns a microfluid device comprising a bag inside a housing, wherein the bag is made of a flexible material and the bag is attached to a mounting, and a method for setting up a microfluid device.

### BACKGROUND OF THE INVENTION

Microfluid devices are used in microfluid systems, where small amounts of fluids are pumped through flow conduits which are often created as small tubes of a small diameter or also created as channels engraved on a surface of a plate. With such a microfluid system it is for example possible to analyse concentrations of species in a fluid. The analysis are commonly based on chemical reactions, wherein reagents are added to a fluid sample which should be analysed. The reagent and the sample fluid react together so that a detectable reaction product is obtained. Since the amount of the observed sample fluid and the reagent is very small, a contamination of a microfluid device can change the result of such an analysis completely. The quality of the analysis also depends on the exact dosage of the necessary fluids.

U.S. Pat. No. 4,796,788 describes a so-called “bag-in-box” packing which is used for products which will not readily flow under gravity conditions for discharge. A replaceable bag comprising two fixed taps is fixed inside a fibre box. The bag is composed of three plies of plastic film which are sealed together at their spherical edges. When the bag is expanded from its flat manufactured state, two separate chambers are produced, a product chamber and a pressure chamber. To dispense the product out of the filled product chamber pressure is introduced onto the pressure chamber, so that the product is squeezed out of the product chamber.

EP 0 415 691 B1 shows another bag-in-box application, where a cap device seals a mouthpiece to maintain a sterilized and sanitary condition of a mouthpiece portion. The mouthpiece is fixed to an inner and an outer bag which are both installed inside a container. In addition, the mouthpiece is exposed to the outer atmosphere of the container which surrounds the bags for liquid storage.

### SUMMARY OF THE INVENTION

It is an object of the invention to simplify the construction of a microfluid device comprising a bag inside a housing and to simplify the installation of such a microfluid device.

In accordance with the present invention, this is achieved in that the mounting is a permanently fixed part of the housing.

The bag inside the housing is designated to store fluid, like a liquid or a gas. Especially, when the microfluid device is used for analysis purpose then a reagent is stored in the bag. Since the bag is flexible, it can change the volume. This means, when there is no liquid inside the bag, then the bag is flat-shaped. When fluid is stored inside the bag, then it has a bigger volume than in the flat-shape status. The bag is fixed inside the housing by means of a mounting. The bag is fixed at least at one location of the bag while it is still possible to change its volume. When the mounting is a part of the housing, then it is not necessary that the bag comprises a separate mounting. The mounting is placed at an inner wall of the housing. This means, the bag which is surrounded by the housing can be fixed to the mounting, so that it is held at a certain place inside the housing. It is also possible that the mounting is fixed at the housing at different locations at one time, for example on two different locations at walls which are arranged vis-à-vis. However, it is preferred to use only one mounting. This makes the setting up of such a device easier and more convenient. Also different sizes of bags can be attached to the same mounting. The bags which do not comprise a mounting are also of advantage when they are stored, because they need less space for storage compared to those bags which comprise a mounting.

In an especially preferred embodiment the mounting is a tap. With a tap it is possible to provide a communication between the inside and the outside of the housing. This means, the preferred mounting has at least two functions. It fixes the bag inside the housing while it enables a fluid communication with a periphery fluid system outside the housing. The tap can conduit the fluid from the inside of the bag to the outside and in the opposite direction from the outside to the inside to fill the bag. A tap which is a fixed part of the housing provides an interface which is independent on the installed bag inside the housing. This means the periphery fluid system can be connected to the tap before the bag is fixed. This ensures convenient and efficient working conditions. When an analysis is conducted then everything can be prepared and in a last step the bag can be mounted. Therefore the use of the microfluid device becomes more flexible.

With advantage the bag is made of a single sheet of a flexible material. A single sheet of material for the bag to be produced reduces the parts to be handled by producing the bag. The sheet could also be covered by a coating. With a coating the bag becomes more resistant when acids or aggressive mediums are filled inside the bag. In common use, only the inner side of the bag is in contact with such mediums. This means, it is also sufficient when only one side of the sheet of material is coated. A flexible sheet of material is for example a sheet of polymer.

Preferably the mounting is welded onto a centre of the sheet and the sheet is folded around the mounting. This simplifies the installation of the microfluid device. The centre of the sheet is the location where the diagonals from one edge to another edge across the sheet cut each other. This means, when the sheet is folded, two borderlines which are arranged vis-à-vis will come in contact. As a result, no additional cutting procedures are necessary to create the bag.

In a preferred embodiment the bag has welded edges. Welding is a suitable procedure to seal the edges of the bag. The edges can be created, when the borderlines of the bags are folded together. During the welding process no particles are produced, which could contaminate the contents of the bag. When bags of different geometry are needed, the same welding tool can be used independent on the shape of the bag.

Advantageously the bag and the mounting are welded together. When the bag has to be installed at the mounting of the housing, then welding is a suitable way to ensure a tightness between the mounting and the bag. Welding is also a time efficient manufacture step of small expenditure of time whereby different geometries of mounting openings, bag sizes, etc. can be easily adapted. When a plastic is chosen for the material of the bag, then a small amount of heat influence is necessary to fix easily the bag to the mounting. When the bag is also manufactured by welding then the same welding tool can also be used for fixing together the bag and the mounting. The manufacture is more efficient when less techniques are used for setting up the microfluid device.

In accordance with a preferred feature, the mounting and a wall of the housing are manufactured as one piece. This means the bag and the housing are in direct contact after installation. An integrated mounting in the housing as one piece with the housing avoids possible leakage problems which can occur between the walls of the housing and the mounting. Also the steps to manufacture the microfluid device are reduced. The manufacture steps for fixing the mounting, checking the correct position of the mounting and proving the sealed connection between the mounting and the housing are not necessary anymore.

In a preferred embodiment a filter is located inside a fluid connection, which connects the inside of the bag with the outside of the housing. The filter can be installed inside the opening of the bag, inside the mounting, between the walls of an opening of the housing, inside a connecting tube which is installed at the housing or any other suitable location. The filter serves the removal of small particles, which might block the micro-channels in the microfluid device. If the microfluid device is used for medical purposes, the filter may provide extra security of sterile fluids.

Advantageously the housing constitutes a pressure chamber. This means the housing is designed to stand a certain pressure per unit area like a pressure tank. The pressure can be an over- or an under-pressure compared to the atmospheric pressure. An over-pressure which is held inside the housing and presses on the bag can squeeze out the medium inside the bag. In contrary, an under-pressure will suck a medium from the outside of the microfluid device to the inside of the bag. Compared to other methods to squeeze out and suck in the medium, for example with mechanical means in the neighbourhood of the bag which influences the bag, a pressure chamber is a convenient solution which can be controlled in a simple way by changing the value of the pressure.

In a further development of the invention the bag comprises plural reservoirs. In practice, different kind of reagents are needed to analyse a sample. It is a convenient way to store these reagents in separate reservoirs, but realised using the same bag inside a common housing. In only one housing several reagents are available which are preferably used for the same analysis. The different reservoirs, this means the different chambers of the bag, can be created by using one manufactured bag. The reservoirs are separated from each other for example by welding two vis-à-vis side walls of the bag together, wherein the welding line is in a distance from the edge of the bag. With one welding line two reservoirs are created.

With advantage the reservoirs are each fixed to one mounting of the housing. To avoid a mutual influence between the reservoirs, a separate mounting for each reservoir is designated. When the housing is transparent, it is possible to view the amount of the different kind of reagents in each reservoir. Then no additional device for detecting the filling of the bags is necessary and each reagent can flow in and out of the reservoir without influencing other reagents.

In accordance with the present invention, the object of the invention is further achieved by a method for setting up a microfluid device, wherein at first, the mounting is fixed at the inside of the housing and then the bag is attached to the fixed mounting.

The housing and the mounting are already one unit when the bag is attached to the mounting. The bag can be manufactured completely before fixing it to the mounting inside the housing. Since the material of the bag is flexible, the bag can be attached to any kind of mounting. Only one manufacture step is necessary to insert the bag inside the housing, namely by fixing the bag to the mounting. This is especially advantageous when the mounting is configured as a tap. In this case no further fitting is necessary for plugged devices on the tap outside the housing. Everything can be prepared in advance. This is of special interest, when the microfluid device is used for different kind of analysis with different kind of bags and different bag sizes.

It is particularly preferred that the bag is made of a single sheet of a flexible material wherein the sheet is folded and boundary lines of the sheet which contact each other after folding the sheet are joined to each other. Since the manufactured bag should comprise a defined volume, less irregularities can be achieved when only one single sheet of material is used. The boundary lines of the sheet can be cut by a cutter or a laser very precisely before folding. When the sheet has a rectangular shape there exist four borderlines. When the sheet is folded, so that the vis-à-vis borderlines are connected to each other, there rest three borderlines which can be sealed to achieve a bag.

In a preferred embodiment the method comprises the step of fixing the bag on the mounting by welding. Welding is an efficient way to fix the bag to the mounting. When using a vacuum moulding or blow forming process the shape of the bag can be formed by this process in addition to fixing it to the mounting.

With advantage the bag is made by blow forming or vacuum moulding. This is a convenient way to create the bag.

### BRIEF DESCRIPTION OF THE DRAWINGS

For a better understanding of this invention and to show how this invention can be carried out, the accompanying drawings illustrate preferred embodiments.

In such drawings:

FIG. 1 shows a sectional view of a first embodiment of a microfluid device,

FIG. 2 illustrates a sectional view of a second embodiment of a microfluid device,

FIG. 3.1, 3.2 and 3.3 demonstrate how a bag is manufactured from a single sheet of a flexible material,

FIG. 4 shows a box-shaped bag which is welded onto the housing,

FIG. 5 illustrates a sectional view of a fluid connection with an installed filter and

FIG. 6 shows a sectional view of a third embodiment of a microfluid device with a bag comprising plural reservoirs.

### BRIEF DESCRIPTION OF THE PREFERRED EMBODIMENTS

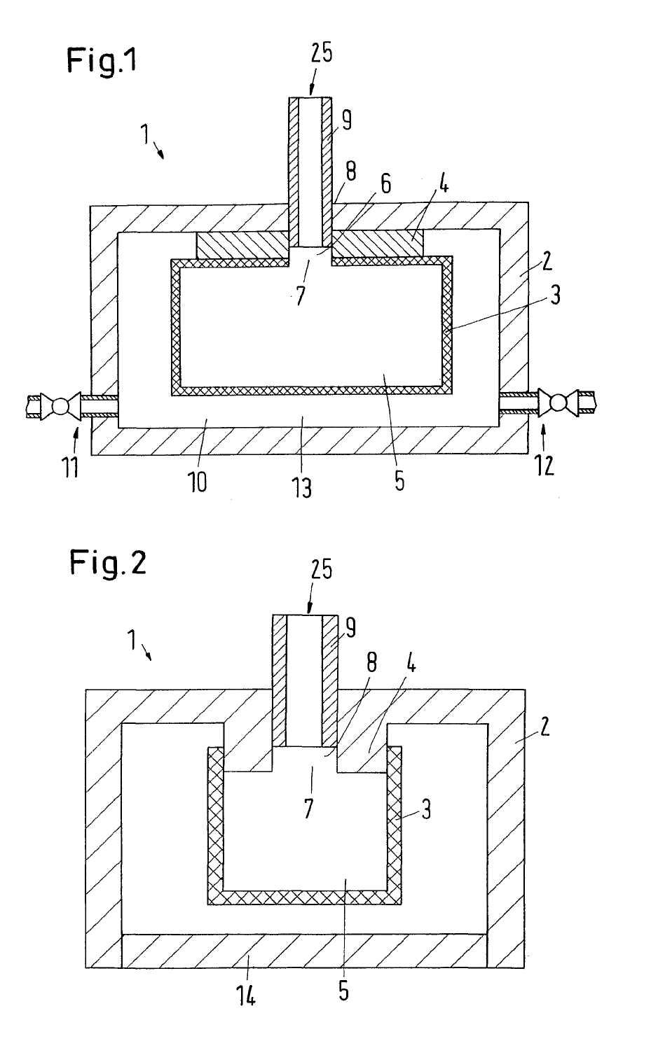

In FIG. 1 a first embodiment of a microfluid device 1 is shown. The microfluid device 1 comprises a housing 2 which is here made of a solid material, for example a plastic or a glass. Inside the housing 2 a bag 3 is installed. The bag 3 is made of a flexible material, for example a plastic foil. The bag 3 is fixed to a mounting 4, which is a part of the housing 2. The mounting 4 is a separate part of the housing 2 and is attached to the housing 2 before the bag 3 is attached to the mounting 4. In the procedure of setting up such a microfluid device 1 the bag 3 can be welded to the housing 2. Under the influence of heat during welding the bag 3 will melt in the contact area of the mounting 4 and therefore it will be fixed at the mounting 4. The bag 3 and the housing 2 are in direct contact to each other.

The mounting 4 is here configured as a tap. This means that a fluid 5 like a liquid or a gas can flow through a first opening 6 at the mounting 4. This opening 6 of the mounting 4 corresponds with a second opening 7 in the bag 3, which both corresponds with a third opening 8 in the housing 2. As a result a fluid from outside the housing 2 can flow to the inside of the housing 2 into the bag 3. Also the other way is possible, that a fluid from the inside of the bag can flow through the openings 6, 7, 8 to the outside of the housing 2 and out of the microfluid device 1. The flow direction of the fluid 5 depends on the pressure conditions inside and outside the housing 2.

The microfluid device 1 is used for chemical analysis, especially for analysing concentration of species in a fluid. Thereby a certain amount of the fluid 5 as a reagent reacts with another fluid, which is to be analysed. Therefore the microfluid device 1 is connected to a tube system wherein one connecting tube 9 is shown in FIG. 1. The tube system may have a certain pressure level inside the tubes. With the help of this pressure it is possible to move the fluid through the tube system. It depends on the pressure which is inside a pressure chamber 10 in relation to the pressure which exists in the tube system outside the housing 2, if the fluid 5 inside the bag 3 will leave the bag 3. The pressure chamber 10 is surrounded by the housing 2 which comprises an inlet 11 and an outlet 12 for a pressure medium 13. The pressure medium 13 is for example a liquid or a gas, e.g. wherein the value of the gas pressure can be controlled at least by control means at the inlet 11 and the outlet 12 of the pressure chamber 10. If the pressure inside the pressure chamber is higher than the pressure inside the tube 9 then the fluid 5 will leave the bag 3, because the flexible material of the bag 3 is compressed by the surrounding pressure medium 13. Also in the case when the fluid 5 has a high viscosity, it will flow into the tube system outside the bag 3. The fluid 5 can be squeezed out in a controlled manner depending on the controlled pressure inside the pressure chamber 10. A constant flow rate can be achieved. Therefore the microfluid device 1 may be used as a liquid storage and a liquid pump at the same time.

In the presented embodiment the tap has one opening. It is also possible, that the tap comprises two or more openings, for example in different directions. When at least one opening of the tap is arranged in the direction of an axis of the gravity force, like it is shown in FIG. 1, then less energy is needed to fill the bag 3. When the bag 3 is filled up, then no fluid 5 will run out by its own. When the fluid 5 is needed at the outside of the bag 3, then an exact dosage is possible, because the outflow of the fluid 5 depends on the forces, which surrounds the bag 3. This forces can be controlled very precisely and therefore a controlled outflow is obtained. Since the mounting 4 is installed completely inside the housing, the possibility of a leakage of the pressure chamber 10 is minimized.

FIG. 2 illustrates a second embodiment of the invention wherein same elements are indicated by the same reference numbers as shown in FIG. 1. In this preferred embodiment the mounting 4 is not a separate part fixed at the housing 2, but the housing 2 and the mounting 4 are one piece. It is preferred that the mounting 4 is an integrated part of the housing 2. This shows FIG. 2 as one possible example of a preferred embodiment. There, the mounting 4 and the bag 3 are welded together. The opening 7 of the bag 3 is here wider than in FIG. 1. The contact area between the mounting 4 and the bag 3 is chosen in a different way compared to FIG. 1. In FIG. 1 the contact area is directed in a horizontal direction while the contact area in FIG. 2 is directed in a vertical direction. In FIG. 2 one wall 14 of the housing 2 is movable. The fluid 5 inside the bag 3 can be squeezed out when the wall 14 is moved towards the bag 3. The wall 14 reduces the volume of the bag 3 mechanically. It is understood that the features shown in FIG. 1 and 2 can be combined with each other.

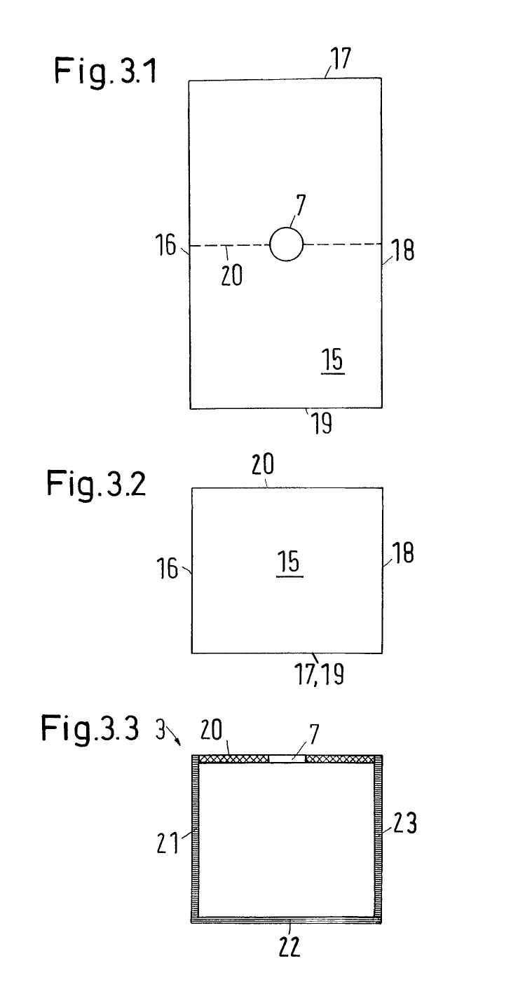

The FIGS. 3.1, 3.2 and 3.3 illustrate schematically how the bag 3 is manufactured from a single sheet 15 of a flexible material. The sheet 15 in FIG. 3.1 has a rectangular shape with four boundary lines 16, 17, 18, 19. At the centre of the sheet 15 the opening 7 of the bag 3 is created, for example by cutting or laser cutting. In a first step of handling this pre-produced sheet 15 the sheet 15 is folded like it is shown in FIG. 3.2. The borderline 17 comes in contact with the borderline 19 of the side vis-à-vis and the borderlines 16 and 18 are folded to themselves, respectively. A new line 20 is created which is not a borderline but a folded line which comprises the opening 7. In a further step of manufacturing the borderlines 16, 17/19 and 18 are welded to form the bag 3. In FIG. 3.3 three welding edges 21, 22 and 23 and the opening 7 are shown in a cross sectional view.

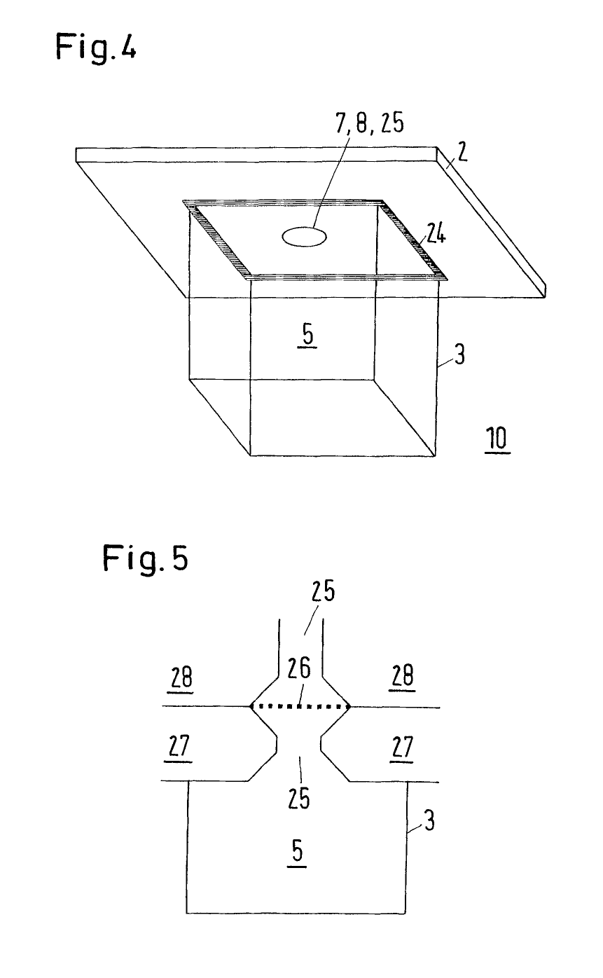

FIG. 4 illustrates a further embodiment with a box-shaped bag 3 which is directly welded onto the housing 2. In this case the mounting 4 and the wall of the housing 2 are manufactured as one piece, whereby the mounting 4 is identical with the wall of the housing 2 and not manufactured as a step-shaped contour like in FIG. 2. For manufacturing the bag 3, a sheet 15 of a flexible material, like an elastomer, is used. The sheet 15 is welded onto the housing 2 along edges 24 of the sheet 15. Subsequently, the sheet 15 is shaped e.g. by means of a vacuum moulding or blow forming process, here onto a box-shape, which gives the contour of the bag 3. Any other shape can also be achieved by using the vacuum moulding process. The box-shape, however, has the advantage that the space inside the pressure chamber 10 can be used to an optimum. The opening 7 of the bag 3 corresponds with the opening 6 of the housing 2 and create together a fluid connection 25 from the inside of the bag 3 to the outside of the housing 2.

FIG. 5 shows a further feature of the microfluid device 1. A filter 26 is located inside the fluid connection 25. Fluid 5 which enters or leaves the bag 3 will pass through this filter 26. The fluid connection 25 has an extended inner diameter, which increases the filter area compared to the openings of the fluid connection 25 towards the bag 3 and towards the outside of the housing 2. This is of advantage, when small particles are stopped by the filter. Hence the area of the filter is wide enough for the passage of further fluid 5. In FIG. 5 the filter 26 is inserted in the microfluid device 1 by means of a two-part-production of the part which is in contact with the bag 3. A first part 27 is for example the mounting 4 while a second part 28 is for example a wall of the housing 2. The filter 26 is fixed between this two parts 27, 28 by jamming.

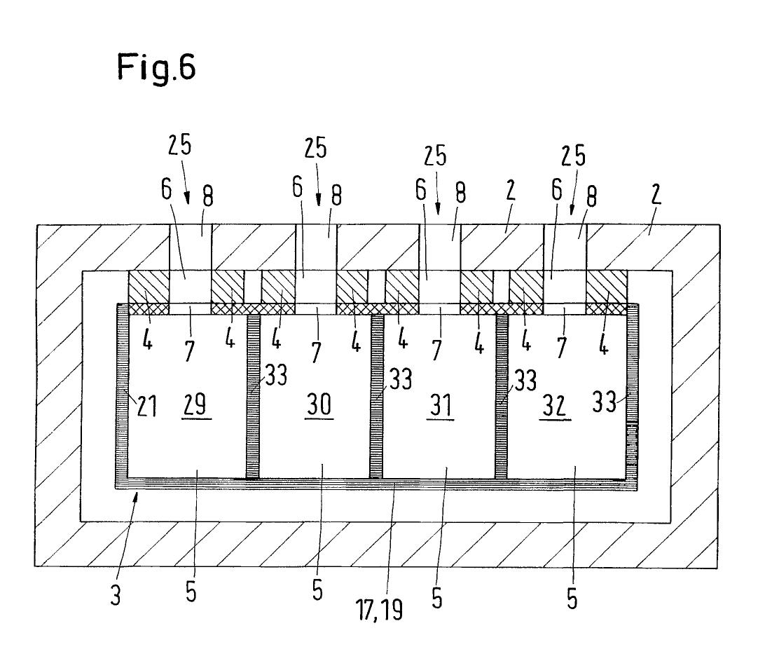

In FIG. 6 a further embodiment of the microfluid device 1 is given. The bag 3 is manufactured of one single sheet 15 of a flexible material, here Polyethylene, and comprises four reservoirs 29, 30, 31, 32. The reservoirs 29 and 30, 30 and 31, 31 and 32 are separated from each other by a welding line 33, respectively. Each reservoir 29-32 is fixed to a separate mounting 4, which is a part of the housing 2. Each mounting 4 is configured as a tap, which connects the inner area of the reservoirs 29-32 via four openings 7 of the bag 3 and a fluid connection 25 to a tube system. Here, four separate mountings 4 are shown. It is also possible to manufacture one single piece which comprises plural mountings 4 and which is fixed to the housing 2 within one working step. It is also possible that the bag 3 with plural reservoirs 29-32 is fixed to the mounting 4 in one working step. This can be done without problems, because the reservoirs 29-32 are made of one piece of material, so that the side of the bag 3 which comprises the openings 7 for the taps are exactly in one line with defined distances to each other. In one step all lines 20 between the openings 7 can be fixed to several mountings 4.

It is obvious that other features described and shown before can be combined with the illustrated embodiment of FIG. 6, for example the pressure chamber 10 which surrounds the bag 3 with the reservoirs 29-32. When such a pressure chamber 10 is used for squeezing out fluid 5 from several reservoirs 29-32 at one time, then also the same amount of fluid will be squeezed out of each reservoir 29-32. This makes an exact dosing convenient. When a squeezing out of a certain reservoir is not desired, then the reservoir or the reservoirs can be blocked for example by a control means at a tube system outside the housing 2.

The described microfluid device 1 is preferably a “single-use-system”. This means that usually the whole microfluid device 1 will be exchanged when for example one part is contaminated or defect. Due to the simplified construction of the microfluid device 1 there is also the possibility to exchange only single parts of the microfluid device 1, like the bag 3, the fluid 5 and/or the housing 2.

It is understood, that all features described and shown in FIG. 1 to 6 are preferred embodiments which can be combined in several ways to create further embodiments which are covered by the invention.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A microfluid device comprising a bag inside a housing, wherein the bag is made of a flexible material and the bag is attached to a mounting, wherein the mounting is a permanently fixed part of the housing.

2. The microfluid device according to claim 1, wherein the mounting is a tap.

3. The microfluid device according to claim 1, wherein the bag is made of a single sheet of a flexible material.

4. The microfluid device according to claim 3, wherein the mounting is welded onto a centre of the sheet and the sheet is folded around the mounting.

5. The device according to claim 1, wherein the bag has welded edges.

6. The microfluid device according to claim 1, wherein the bag and the mounting are welded together.

7. The microfluid device according to claim 1, wherein the mounting and a wall of the housing are manufactured as one piece.

8. The microfluid device according to claim 1, wherein a filter is located inside a fluid connection, which connects the inside of the bag with the outside of the housing.

9. The microfluid device according to claim 1, wherein the housing constitutes a pressure chamber.

10. The microfluid device according to claim 1, wherein the bag comprises plural reservoirs.

11. The microfluid device according to claim 10, wherein the reservoirs are each fixed to one mounting of the housing.

12. A method for setting up a microfluid device, comprising a bag inside a housing, wherein the bag and the housing are fixed to each other by a mounting, wherein at first, the mounting is fixed at the inside of the housing and then the bag is attached to the fixed mounting.

13. The method according to claim 12, wherein the bag is made of a single sheet of a flexible material wherein the sheet is folded and boundary lines of the sheet which contact each other after folding the sheet are joined to each other.

14. The method according to claim 12, comprising the step of fixing the bag on the mounting by welding.

15. The method according to claim 12, wherein the bag is made by blow forming or vacuum moulding.
